(19) United States
(12) Patent Application Publication
(10) Pub. No.: US 2026/0089827 A1
(43) Pub. Date: Mar. 26, 2026

(54) PLASMA REACTOR

(71) Applicant: CAPHENIA GMBH, Bernau a. Chiemsee (DE)

(72) Inventor: Nils MYKLEBUST, Trondheim (NO)

(21) Appl. No.: 19/112,632

(22) PCT Filed: Sep. 8, 2023
(86) PCT No.: PCT/EP2023/074763

§ 371 Date: Mar. 18, 2025

(30) Foreign Application Priority Data
Sep. 20, 2022 (DE) 102022124117.3

(51) Int. Cl. H05H 1/34; B01J 19/08; C01B 3/24; H05H 1/28; H05H 1/42

(52) U.S. Cl. CPC H05H 1/3431; B01J 19/088; C01B 3/24; H05H 1/28; H05H 1/3423; H05H 1/42; B01J 2219/0894; C01B 2203/0861; H05H 2242/10; H05H 2245/10

(57) ABSTRACT

A plasma reactor for decomposing a hydrocarbon fluid includes a reactor chamber and a plasma torch attached to a wall of the reactor chamber and including an inner tubular electrode and an outer tubular electrode. A feed lance projecting into the reactor chamber is arranged inside the inner tubular electrode and is displaceable relative to the tubular electrodes by way of a sliding mechanism. A plasma gas outlet for dispensing plasma gas is between the inner tubular electrode and the outer tubular electrode, and an oxidizing fluid outlet for dispensing oxidizing fluid preferably including CO₂ or H₂O is disposed within the inner tubular electrode. Related methodology is also disclosed.

The present invention relates to a plasma reactor and to a method of operating a plasma reactor.

### PRIOR ART

Prior art plasma reactors for decomposing a hydrocarbon fluid are known, wherein these plasma reactors comprise a reactor chamber and a plasma torch projecting into the reactor chamber and capable of generating a high temperature of more than 1000° C. A hydrocarbon fluid is introduced into the plasma reactor and decomposed at high temperature into an aerosol of carbon and hydrogen, i.e. an H₂/C aerosol.

For example, WO 93/12634 describes such a plasma reactor which comprises a reactor chamber and a plasma torch attached to a wall of the reactor chamber, projecting into the reactor chamber, and having a free end. The plasma torch comprises an inner tubular electrode, an outer tubular electrode, and a feed lance for dispensing hydrocarbon fluid, the feed lance being disposed within the inner tubular electrode. In such known plasma reactors, the problem arises that carbon deposits grow up at the inlets for hydrocarbon fluid (fouling), which can jam the inlets. This can cause damage to the electrodes and malfunction of the method. Therefore, various attempts have been made to prevent carbon deposits. Nevertheless, carbon deposits could not be avoided, and only relatively short operating times of the plasma reactors could be achieved. Another problem is that the liquid-cooled feed lance is prone to leaks, which can lead to damages of the electrodes and the reactor.

### General Description of the Invention

It is the object of the present invention to overcome the disadvantages described above, and in particular to provide a plasma reactor which can achieve long uninterrupted operating times. This task is solved by a plasma reactor according to claim 1 and by a method for operating a plasma reactor according to claim 8.

The above object and other problems are solved by a plasma reactor for decomposing a hydrocarbon fluid, comprising a reactor chamber and a plasma torch, wherein the plasma torch is attached to a wall of the reactor chamber, projects into the reactor chamber and has a free end. The plasma torch comprises an inner tubular electrode and an outer tubular electrode, which at least partially surrounds the inner tubular electrode. A feed lance for dispensing hydrocarbon fluid is disposed within the inner tubular electrode and is displaceable relative to the tubular electrodes by means of a sliding mechanism during operation of the plasma reactor. Accordingly. the sliding mechanism is configured to axially move the feed lance in operation while plasma is generated in the plasma reactor. The plasma reactor further comprises a plasma gas outlet for dispensing plasma gas, the plasma gas outlet being disposed between the inner tubular electrode and the outer tubular electrode, and further comprises an oxidizing fluid outlet for dispensing oxidizing fluid, wherein the oxidizing fluid preferably comprises CO₂ or H₂O, and wherein the oxidizing fluid outlet is disposed within the inner tubular electrode. The hydrocarbon fluid is preferably a gas and has a composition CₙHₘ, where n and m are integers and where n≥1 and m≥2. A source of plasma gas is connected to the plasma gas outlet, a source of oxidizing fluid is connected to the oxidizing fluid outlet, and a source of hydrocarbon fluid is connected to the feed lance. In this arrangement, the dispensed hydrocarbon fluid flows along the inner tubular electrode to the free end of the plasma torch where, in operation, the plasma is generated. In the absence of oxygen, the hydrocarbon fluid is decomposed into a mixture of H₂ and C particles, also known as H₂/C aerosol. A portion of the C particles may form carbon deposits on the electrode. On the other hand, graphite or carbon electrodes may erode or wear during operation under the influence of the plasma or arc between the electrodes.

On the one hand, moving the feed lance relative to the tubular electrodes allows to protect the electrodes by deposition of carbon at various locations on the electrodes, wherein the flow of hydrocarbon fluid-through the feed lance may be controlled to facilitate carbon deposition.

On the other hand, if there are too many carbon deposits on the electrodes or on the feed lance, reduction of carbon deposits is possible by controlling the position of the oxidizing fluid outlet and the flow of oxidizing fluid through it so that the oxidizing fluid can reduce or consume the carbon deposits. This keeps the feed channel of the feed lance open for hydrocarbon fluid.

Third, the feed lance can be moved to a cooler area, i.e. away from the plasma zone at the free end of the electrodes, e.g. at the beginning and at the end of operation or when the electrode is shortened due to wear. Then a worn electrode can be restored to full length later, and the operating time can be extended.

The inner and outer tubular electrodes each have a hollow interior space and preferably a round cross-section. However, the electrodes may have any other cross-sections. When the inner electrode is located in the interior space of the outer electrode, a gap is formed between the inner and outer electrodes through which plasma gas can be passed. The electrodes are made of an electrically conductive heat-resistant material that can withstand the temperatures in the environment of a plasma arc during operation. The heat-resistant material for the electrodes can be, for example, a metal, an electrically conductive ceramic material, carbon, or graphite, and these materials can also be fiber-reinforced.

In a first embodiment of the plasma reactor, the oxidizing fluid outlet is a part of the feed lance. For example, the feed lance has a first outlet for oxidizing fluid and a second outlet for hydrocarbon fluid. In another embodiment of the plasma reactor, the oxidizing fluid outlet is formed by an annular space between the inner tubular electrode and the feed lance, wherein an oxidizing fluid is passed between the inner surface of the inner electrode and the outer periphery of the feed lance. Dispensing of the oxidizing fluid can be switched between the two cases for building up the electrode with carbon or reducing carbon deposits. That means the source of oxidizing fluid can be connected to the first outlet for oxidizing fluid or to the annular space between the inner tubular electrode and the feed lance. In both cases, the oxidizing fluid is dispensed inside the inner tubular electrode, and the positive effects described above can be achieved, i.e. selectively building up the electrode with carbon and reducing carbon deposits.

When the oxidation fluid outlet is part of the feed lance, the plasma torch preferably comprises a feed lance formed, inter alia, by an inner tube and an outer tube which at least partially surrounds the inner tube. In this case, the oxidation fluid outlet is formed either by the inner tube or by a space between the inner tube and the outer tube. When the oxidizing fluid outlet is formed by the inner tube, the oxidizing fluid does not directly contact the inner electrode. Advantageously, the inner tube and the outer tube of the feed lance are movable relative to each other in their longitudinal direction so that the mouths of the tubes can be positioned at different locations with respect to the electrodes and with respect to the free end of the plasma torch. This allows for better adjustment of the positions of carbon buildup and degradation. Also in this case, the sliding mechanism is configured to axially move the inner/outer tube of the feed lance in operation while plasma is generated in the plasma reactor.

If the inner electrode is made of carbon or graphite, the oxidizing fluid may affect the inner electrode. In this case, it is advantageous if the oxidizing fluid outlet is a part of the feed lance and is formed by the inner tube of the feed lance, and the outlet for dispensing hydrocarbon fluid is formed by a space between the inner tube and the outer tube. Thus, the hydrocarbon fluid interposes between the electrode and the centrally dispensed oxidizing fluid like a protective curtain.

In any of the embodiments described above, a thermal insulating layer may optionally be disposed on the outside of the feed lance or on the inside of the inner electrode to protect these components from the heat of the plasma or from heat from the inner electrode during operation.

In all embodiments described above, the feed lance is optionally connected to the inner electrode by at least one electrically conductive element such that the feed lance and the inner electrode have the same electrical potential. By having the same electrical potential, an electrical flashover from the electrodes to the feed lance is avoided or at least the probability of a flashover is reduced. Alternatively or additionally, an insulation layer may be provided on the inner electrode or on the feed lance, the insulation layer being both electrically insulating and insulating against heat.

Advantageously, a structure is provided in the feed lance to swirl the injected hydrocarbon fluid. Alternatively or additionally, a structure is provided in the oxidation fluid outlet to create swirling of the oxidizing fluid, in particular CO2 and/or H₂O.

Preferably, the plasma reactor further comprises an annular magnet arranged on the outside of the reactor wall at the level of the free end of the electrodes. The magnet can generate a movement of the electric arc at the electrodes and a turbulence of the materials in the reactor chamber by Lorenz force. To enhance this positive technical effect, preferably a part of the reactor wall near the magnet is made of an austenitic metal in particular austenitic steel, stainless steel or metal mixtures with an austenitic portion. Another technical advantage arises in an embodiment where the inner electrode has a positive electrical potential, the outer electrode has a negative electrical potential, and the free end of the electrodes is located at the upper edge of the annular magnet, since the operation of the arc can be better stabilized. However, the operation of the arc can be stabilized in the same way in a similar embodiment where the free end of the electrodes is arranged at the lower edge of the annular magnet and where the inner electrode have a negative electric potential and the outer electrode have a positive electric potential.

In an advantageous embodiment, the reactor chamber comprises an outlet opposite the plasma torch, and a heat exchanger is arranged directly at the outlet of the reactor chamber. Preferably, the outlet of the reactor chamber merges directly with the inlet of the heat exchanger. When the plasma reactor is configured to produce a stream of syngas comprising CO and H₂, the heat exchanger is preferably adapted to effect cooling of the stream of syngas by 800-1000° C., in particular to effect cooling from 1400-1200° C. to a temperature range of 200-400° C. This serves as a quench, which achieves fixation of the synthesis gas and avoids back reactions. Optionally, the heat exchanger is designed to effect cooling of the stream of synthesis gas within 1-3 seconds, preferably within 2 seconds.

The object and other problems mentioned above are solved by a method of operating a plasma reactor, according to one of the embodiments described above, the method comprising the steps of:
measuring a mass flow of the oxidizing fluid or hydrocarbon fluid prior to dispense within the inner tubular electrode;
controlling the dispense of oxidizing fluid from the oxidation fluid outlet based on a change in the mass flow;

In operation, carbon may deposit on the inside of the inner electrode or at an outlet of the feed lance. If the feed pressure remains constant, the mass flow of the oxidizing fluid or hydrocarbon fluid may change based on an amount of the deposited carbon. A decreasing mass flow will be related to the buildup of carbon deposits as the flow cross-section within the inner tubular electrode is reduced by the carbon deposits.

Similarly, the inlet pressure of the oxidizing fluid or hydrocarbon fluid may change while the mass flow remains the same when carbon deposits build up. Therefore, the method may comprise the following steps for obtaining the same effect:
measuring a pressure or pressure history of the oxidizing fluid or hydrocarbon fluid prior to dispense within the inner tubular electrode;
controlling the dispense of oxidizing fluid from the oxidizing fluid outlet based on a change in pressure;
or
measuring a mass flow or mass flow history of the oxidizing fluid or hydrocarbon fluid prior to dispense within the inner tubular electrode; controlling the dispense of oxidizing fluid from the oxidizing fluid outlet based on a change in mass flow.

In the method, the dispense of oxidizing fluid is consequently controlled based on such change in mass flow or pressure at dispense, i.e. more oxidizing fluid when carbon deposits are large; and less or no oxidizing fluid when carbon deposits are small. The oxidizing fluid breaks down the carbon deposits. Consequently, by carrying out this method, the positive effects described above can be achieved. Also, when very high temperature, radiation, and other extreme conditions are present in the reactor chamber during operation, measuring the mass flow provides feedback on a condition of the electrodes, oxidizing fluid outlet, and feed lance, and on a buildup or degradation of carbon deposits, wherein such feedback has not been possible before.

In a first embodiment of the method, the step of dispensing the oxidizing fluid is performed through an outlet in the feed lance, for example through a first outlet for oxidizing fluid, and a second outlet for hydrocarbon fluid. In a second embodiment of the method, the step of dispensing oxidizing fluid is performed through an annular space between the inner tubular electrode and the feed lance, wherein an oxidizing fluid is passed between the inner surface of the inner electrode and the outer periphery of the feed lance. In a third embodiment of the method, the hydrocarbon fluid and the oxidizing fluid are dispensed through a single or common tube of the feed lance, (a) alternating in time (first hydrocarbon fluid, then oxidizing fluid through the same tube and vice versa), or (b) mixed together. In all cases, the oxidizing fluid can remove the carbon deposits, thereby keeping the hydrocarbon fluid feed channel open.

Additionally, the method may comprise the step of variably mixing hydrocarbon fluid, CO₂ and/or H₂O based on a measured amount of wear of at least one of the tubular electrodes. Further, the hydrocarbon fluid, CO₂ and/or H₂O may be variably mixed based on a measured amount of a deposit of solids (i.e. solid carbon deposits) on at least one of the tubular electrodes. For example, the wear or amount of a deposit of solids may be measured optically, e.g., via laser, camera, or other known optical methods.

Preferably, the feed lance is axially displaced relative to the inner tubular electrode based on a change in the mass flow or pressure of the feed. Similarly, the oxidation fluid outlet can be shifted axially relative to the inner tubular electrode.

In one embodiment, the step of dispensing oxidizing fluid is carried out via an outlet that is part of the feed lance, and the feed lance comprises an inner tube and an outer tube that at least partially surrounds the inner tube. In this case, a first version of the method provides the step of passing the oxidizing fluid through the inner tube and passing the hydrocarbon fluid through a space between the inner tube and the outer tube. The oxidizing fluid then keeps the inner tube clear, and the hydrocarbon fluid is passed close to the inner electrode. In a second version of the method, this embodiment of the feed lance provides the step of passing the oxidizing fluid through a space between the inner tube and the outer tube. The oxidizing fluid is then passed close to the inner electrode and can rapidly reduce carbon deposits on the electrode.

In any of the above embodiments of the method, a cooling gas having a lower temperature than the inner tubular electrode may be introduced through the feed lance when hydrocarbon fluid is not introduced. As an example, the cooling gas may have a temperature of less than 700° C., preferably less than 550 since the temperature of the inner tubular electrode is higher. The cooling gas replaces the cooling effect of the hydrocarbon fluid and prevents cracking or other damage to the electrodes and feed lance caused by temperature changes.

Furthermore, in all embodiments of the method described above, a pressure within the reactor chamber can be adjusted to a range of 10 to 30 bar.

Likewise, in all the embodiments of the method described above, a temperature at the inlet of the heat exchanger can be adjusted to 1100-1300° C., preferably to 1200° C. These measures improve the yield of the plasma reactor.

### BRIEF DESCRIPTION OF THE DRAWINGS

The invention and further details and advantages thereof are explained below with reference to preferred examples of embodiments shown in the figures.

FIG. 1 shows a plasma reactor for decomposing a hydrocarbon fluid, the plasma reactor comprising a reactor chamber and a plasma torch;

FIG. 2 an enlarged detail A of the plasma torch in FIG. 1;

FIG. 3 an enlarged detail A of the plasma torch in FIG. 1 in operation; and

FIG. 4 a split electrode of the plasma torch in FIG. 1.

### DETAILED DESCRIPTION

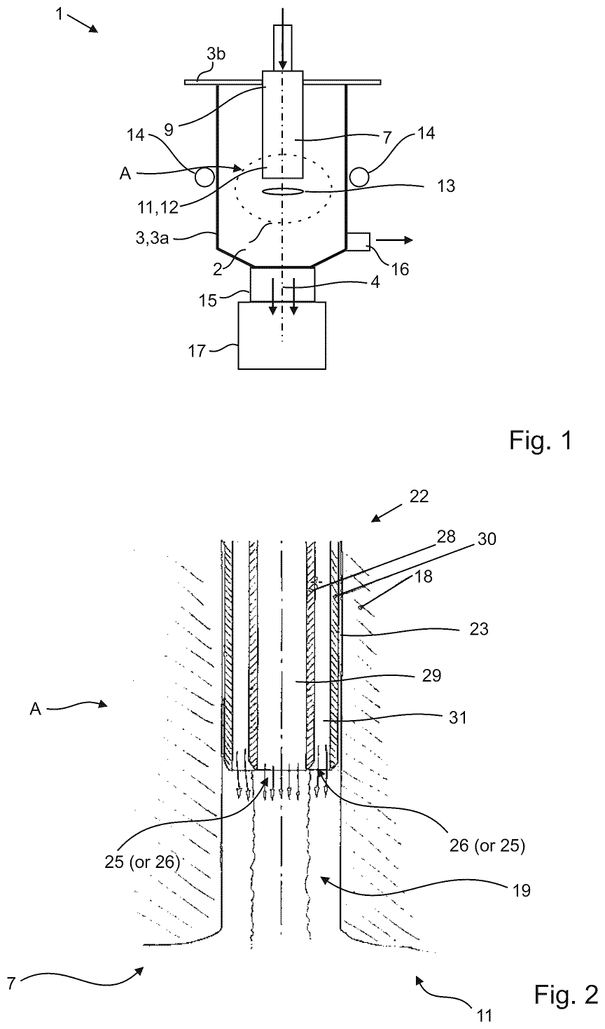

In the present description, the expressions above, below, right and left and similar indications refer to the orientations or arrangements shown in the figures and only serve to describe the embodiments. These expressions may show preferred arrangements but are not to be understood in a limiting sense. Among other things, the plasma reactor shown in FIG. 1 could be installed in a different orientation, for example reclined or horizontal. Further, the expressions “substantially”, “approximately”, “about” and similar expressions mean that deviations of +/−10%, preferably +/−5%, from said value are permissible. The term hydrocarbon fluid in the context of this description means a fluid (gas, aerosol, liquid) containing hydrocarbons, for example natural gas, methane, liquefied petroleum gas, biogas, or liquid atomized hydrocarbons or a mixture thereof.

The plasma reactor 1 according to the present disclosure comprises a reactor chamber 2 enclosed by a reactor wall 3, which comprises a lower part 3a and a cover 3b. The reactor chamber 2 may also be divided at a different location than shown in FIG. 1. The reactor chamber 2 is substantially cylindrical and has a central axis 4. A plasma torch 7 is attached to the reactor wall 3 (here attached to the cover 3b), which comprises elongated electrodes (shown in more detail in FIGS. 2 and 3). The plasma torch 7 may be attached to the reactor wall 3 by means of an electrode holder or plasma torch holder (not shown). In the example of FIG. 1, the cover 3b acts as the electrode holder, but an additional electrode holder may be provided on the cover 3b. The plasma torch 7 comprises a base portion 9 that is attached to the reactor wall 3 (to the cover 3b or electrode holder). The plasma torch 7 comprises at its other end, opposite to the base part 9, a torch part 11 at a free end 12 of the electrodes, which projects into the reactor chamber 2. A plasma 13 is formed between and outside the electrodes by a plasma gas and an electric arc. An annular magnet 14 is arranged on the outside of the reactor wall 3 at the level of the free end 12 of the electrodes and influences the electric arc by magnetic force. The magnet 14 can produce a movement of the arc at the electrodes and a swirling of the materials in the reactor chamber 2 by Lorenz force. To enhance this positive effect, a part of the reactor wall 2 may be made of an austenitic metal in particular austenitic steel, stainless steel or metal mixtures with austenitic content. In a first further improvement, the free end of the electrodes is located at the top edge of the annular magnet, the inner electrode having a positive electrical potential and the outer electrode having a negative electrical potential. In a second further improvement, the free end of the electrodes is located at the bottom edge of the annular magnet, with the inner electrode having a negative electrical potential and the outer electrode having a positive electrical potential. With these two combinations of electrode potential and magnet position, the force fields of the magnet and the arc add together to better stabilize the operation of the arc.

At the other end of the reactor chamber 2, opposite the plasma torch 7, the plasma reactor 1 comprises an outlet 15 through which the substances resulting from the decomposing of the injected hydrocarbon fluid can escape. The outlet 15 is arranged in the flow direction at the opposite end of the reactor chamber 2 and may be larger or smaller than shown in the figures.

However, for ease of distinction, the outlet 15 is shown in FIG. 1 to be smaller than the reactor chamber. Optionally, a secondary outlet 16 may be provided at the lower end of the reactor chamber 2. A heat exchanger 17 is arranged directly at the outlet 15 of the reactor chamber 2. Preferably, the outlet 15 merges directly into the inlet of the heat exchanger 17. Since the plasma reactor 1 is configured to generate a stream of synthesis gas comprising CO and H₂, the heat exchanger 17 is designed to cause cooling of the stream of synthesis gas by 800 to 1000° C., in particular cooling of 1400-1200° C., such that the synthesis gas at the outlet of the heat exchanger 17 is in a temperature range of 200-400° C. This arrangement serves as a quench (stage and step for cooling), whereby the synthesis gas is fixed, and back reactions are avoided. For example, the heat exchanger 17 is a tubular heat exchanger with multiple stages that are interconnected. Here, the heat exchanger 17 is designed to effect cooling of the stream of synthesis gas within 1-3 seconds, preferably within 2 seconds.

The reactor chamber 2 may also have an enlarging flow cross-section, which increases between the upper end (at the cover 3b) and the outlet 15 (measured perpendicular to the longitudinal extent of the second reaction chamber). Advantageously, the reactor chamber 2 does not comprise a substantial reduction in flow cross-section between the upper end and the outlet 15. In particular, the reactor chamber 2 an enlarge conically to provide for a continuous, uniform increase in the flow cross-section. However, it would also be possible to provide a stepped increase or, for example, several different conical expansions. However, such an expanding flow cross-section may remain the same over a small range compared to the length (less than about 10%).

FIG. 2 shows an enlarged detail A of the torch portion 11 at the free end of the plasma torch 7. The plasma torch 7 comprises an inner tubular electrode 18 and an outer tubular electrode 20 (see FIG. 3) which surrounds the inner tubular electrode 18. The electrodes 18 and 20 each have a hollow interior, which has a circular cross-section in the shown example. When the inner electrode 18 is disposed within the interior space of the outer electrode 20, a gap 24 (FIG. 3) is formed between the electrodes 18 and 20. That is, the electrodes 18 and 20 are arranged as if they were tubes fitted together. The electrodes 18 and 20 are made of an electrically conductive heat-resistant material that can withstand the temperatures of a plasma arc in operation (metal, an electrically conductive ceramic material, carbon, or graphite). For the following description, it is assumed that electrodes 18 and 20 are made of carbon or graphite.

The gap 24 between the inner tubular electrode 18 and the outer tubular electrode 20 is connected to a source of plasma gas (not shown), thus forming a plasma gas outlet for dispensing plasma gas into the reactor chamber 2.

Valves are arranged between the source of plasma gas and the gap 24, wherein the dispense of plasma gas can be controlled via the valves.

The plasma torch 7 further has a feed lance 22 for dispensing hydrocarbon fluid into the reactor chamber 2. The feed lance 22 is arranged inside the inner tubular electrode 18, i.e., in its hollow interior space 19, and is displaceable relative to the tubular electrodes. Optionally, an electrically and thermally insulating layer (not shown) may be arranged on the outside of the feed lance 22 or on the inside of the inner electrode. The feed lance 22 may comprise a structure, such as guide vanes or inclined nozzles, for swirling the introduced hydrocarbon fluid. Alternatively or additionally, a guide structure having a similar effect is provided in the oxidizing fluid outlet to produce swirling of the oxidizing fluid, particularly CO₂ and/or H₂O. The feed lance 22 is connected to a source of hydrocarbon fluid (not shown).

The plasma torch 7 also has an oxidizing fluid outlet for dispensing oxidizing fluid. The oxidizing fluid outlet is located within the inner tubular electrode and is connected to a source of oxidizing fluid. The oxidizing fluid is adapted to oxidize carbon and preferably comprises CO₂ or H₂O.

In a first embodiment of the plasma torch 7, the oxidizing fluid outlet is formed by an annular gap 23 between the inner tubular electrode 18 and the feed lance 22. Therein, the oxidizing fluid is simply directed between the inside of the inner electrode and the outer periphery of the feed lance. This embodiment has the advantage that carbon deposits on the inner surface of the inner electrode 18 can be rapidly dissolved (i.e., oxidized). Preferably, however, the annular gap 23 is connected to a source of plasma gas that does not oxidize or otherwise degrade the inner surface of the inner electrode 18.

In a second embodiment of the plasma torch 7, shown in FIGS. 2 and 3, the oxidizing fluid outlet is a part of the feed lance 22 having a first outlet 25 for oxidizing fluid and a second outlet 26 for hydrocarbon fluid. The feed lance 22 is formed by, among other things, an inner tube 28 having an interior space 29 and an outer tube 30 surrounding the inner tube 28. Thus, an intermediate space 31 is formed between the inner tube 28 and the outer tube 30. This second embodiment of the plasma torch 7 again provides multiple operating modes (A), (B), and (C), which may also be applied sequentially in time.

First operating mode (A) In the arrangement shown in FIGS. 2 and 3, oxidizing fluid is passed through the interior space 29 of the inner tube 28 so that the interior space 29 forms the outlet for oxidizing fluid. Hydrocarbon fluid is passed through the intermediate space 31 between the inner tube 28 and the outer tube 30, so that the intermediate space 31 forms the outlet for hydrocarbon fluid. In operation, the hydrocarbon fluid flows between the inner electrode 18 and the centrally dispensed oxidizing fluid so that the oxidizing fluid does not directly contact the inner electrode 18. When operating with an electrode made of carbon or graphite, this operating mode (A) has the effect that the oxidizing fluid will not degrade the inner electrode 18 as much.

Second operating mode (B) In the arrangement shown in FIGS. 2 and 3, hydrocarbon fluid is passed through the interior space 29 of the inner tube 28 so that the interior space 29 forms the outlet 26 for hydrocarbon fluid.

Oxidizing fluid is passed through the intermediate space 31 between the inner tube 28 and the outer tube 30, so that the intermediate space 31 forms the outlet for oxidizing fluid. In operation, the oxidizing fluid flows between the inner electrode 18 and the centrally dispensed hydrocarbon fluid so that the hydrocarbon fluid does not come into direct contact with the inner electrode 18. This operating mode (B) has the effect that carbon deposits on the inside of the inner electrode 18 can be rapidly dissolved (i.e. oxidized). Compared to operating mode (A), there is also the effect that the carbon particles of the H₂/C aerosol cannot deposit so easily on the inner electrode 18.

The feed lance 22 is displaceable relative to the tubular electrodes 18, 20 in the direction of the center axis 4. In particular, the feed lance 22 is displaceable relative to the inner electrode 18. Further, the inner tube 28 and the outer tube 30 of the feed lance 22 may be displaceable relative to each other. For example, the inner tube 28 in FIG. 3 protrudes from the outer tube 30, while the ends of the tubes 28 and 30 in FIG. 2 are at the same level. This allows to affect the temperature range and flow characteristics when hydrocarbon fluid and oxidizing fluid are introduced.

Third operating mode (C) The hydrocarbon fluid and the oxidizing fluid may be dispensed through a single or common tube of the feed lance, (a) alternating in time (first hydrocarbon fluid, then oxidizing fluid through the same tube and vice versa), or (b) mixed together, although this is not shown in the figures.

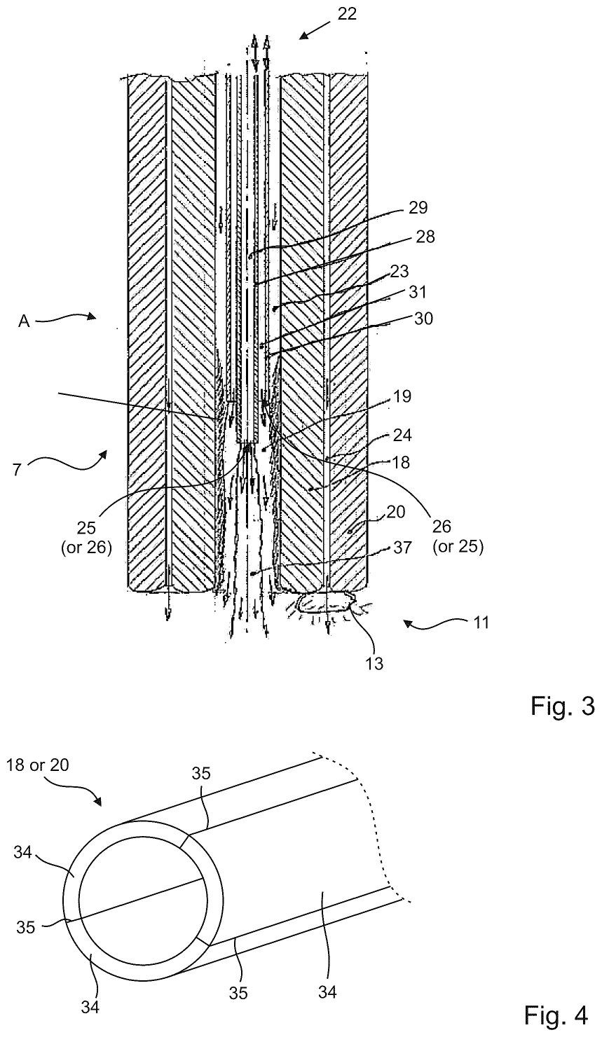

Optionally, at least one of the tubular electrodes 18, 20 comprises tubular segments 34 which are separated in the direction of the longitudinal axis of the electrodes 18, 20. The tubular segments 34 are shell-shaped and together form an electrode 18, 20. When a cylindrical tubular electrode 18, 20 is cut twice in the direction of its longitudinal axis, two shell-shaped tubular segments 34 are formed, wherein each extends over 180°, and they are separated by two longitudinal slots. In FIG. 4, a cylindrical tubular electrode 18, 20 is shown which is cut through three times in the direction of its longitudinal axis (see longitudinal slots 35), resulting in three shell-shaped tubular segments 34, wherein each extends over 120°, and wherein they form the tubular electrode 18 or 20 in the assembled state. The shell-shaped tubular segments 34 are in close contact with each other, so that the longitudinal slots 35 are very small to allow as little or no gas (i.e. plasma gas) to escape between the tubular segments 34. For example, the shell-shaped tube segments 34 may abut smoothly against each other, may comprise a tongue and groove interface, or may comprise a labyrinth seal.

Alternatively, at least one of the tubular electrodes 18, 20 comprises annular tubular parts arranged in a row (not shown in Figs.). The annular tubular parts may be interconnected, for example, glued, by screw connections or plug connections. When three annular tubular parts are arranged in a row, the entire tubular electrode is formed by first, second and third annular tubular parts screwed or plugged together. In this case, the first tubular part is at the free end 12 of the plasma torch 7, the second tubular part is in the middle, and the third tubular part is at the end of the plasma torch 7, wherein the end is attached to the reactor chamber 2 (e.g., to the cover 3b or to an electrode holder).

The shell-shaped tube segments 34 or the annular tube parts help to compensate for differences in thermal expansion. By adding annular tube parts, it is also possible to keep the electrode length within a certain range when the electrodes 18, 20 wear out in the arc zone. In addition, parts of electrodes 18, 20 can be replaced, which is useful for electrodes made of carbon or graphite. The shell-shaped tube segments 34 or the annular tube parts can be secured by mounting elements, e.g. by pins, especially pins made of carbon or graphite.

In operation, the plasma reactor 1 described above generally operates according to the following method for decomposing a hydrocarbon fluid.

Plasma gas is dispensed between the inner tubular electrode 18 and the outer tubular electrode 20, and a portion of the plasma gas meeting the arc between the electrodes is excited to form a plasma 13. The plasma 13 is formed in the vicinity of the torch portion 11, and the plasma gas has average temperatures of more than 2500° C. after passing through the arc, but may locally reach higher temperatures up to 4900° C. In particular, if carbon or graphite electrodes are used for the plasma torch 7, as is assumed here, a portion of the electrodes 18, 20 may erode due to high temperature and electric sparking of the arc.

Hydrocarbon fluid (preferably natural gas or methane) is dispensed within the inner tubular electrode 18. At the high temperatures in the reactor chamber 2, the hydrocarbon fluid is decomposed to hydrogen (H₂ gas) and carbon (C particles) since there is no oxygen in the reactor chamber 2. The carbon and hydrogen escape as a H₂/C aerosol from the interior space 19 of the inner electrode 18 and travel in the direction of the center axis 4 to the outlet 15. A portion of the H₂/C aerosol can be removed via the optional outlet 16.

A portion of the resulting carbon may be deposited on surrounding components and may form solid carbon deposits. In particular, the interior space 19 of the inner electrode 18 and the feed channels of the feed lance 22 can become overgrown with carbon deposits and may be even completely jammed. This changes the operating characteristics. As the carbon deposits grow, the remaining flow cross-section of the inner space 19 and the feed channels of the feed lance 22 (i.e. the interior space 29 and the intermediate space 31) becomes smaller. Consequently, the inflow of oxidizing fluid and/or hydrocarbon fluid is throttled and the mass flow is reduced. If a large reduction in mass flow is measured, this is an indication of heavy carbon buildup. If there is little change in mass flow, this is an indication of no or little carbon buildup.

To maintain a constant mass flow, the feed pressure of the oxidizing fluid and/or of the hydrocarbon fluid can be increased first to keep the mass flow the same.

If increasing the feed pressure is undesirable or insufficient to counteract the throttling effect, oxidizing fluid (CO₂ or HO) is dispensed within the inner tubular electrode 18. Alternatively, or in addition, the feed lance may be axially displaced relative to the inner tubular electrode in response to a change in mass flow. The oxidizing fluid may oxidize carbon at the high operating temperature in the reactor chamber 2 to form carbon monoxide (C+CO₂>CO) or synthesis gas (C+H₂O>CO+H₂). In addition, the feed lance is cooled by the hydrocarbon fluid and the oxidizing fluid.

In FIGS. 2 and 3, the feed lance comprises the inner tube 18 and the outer tube 20, which allows the above-described operating modes (A), (B) and (C). Operating mode (A) Oxidizing fluid is passed through the interior space 29 of the inner tube 28, and hydrocarbon fluid is passed through the intermediate space 31 between the inner tube 28 and the outer tube 30. Operating mode (B) Hydrocarbon fluid is passed through the interior space 29 of the inner tube 28, and oxidizing fluid is passed through the intermediate space 31 between the inner tube 28 and the outer tube 30. Operating mode (C) The hydrocarbon fluid and the oxidizing fluid can be dispensed through a single or common tube of the feed lance, (a) alternating in time (first hydrocarbon fluid, then oxidizing fluid through the same tube and vice versa), or (b) mixed together, although this is not shown in the figures. In doing so, the tube orifice may be moved to locations where carbon deposits are to be removed or added.

The process of dispensing (i.e., controlling the mass flow and feed pressure) the oxidizing fluid is controlled depending on the operating condition of the plasma reactor 1.
When heavy carbon deposits are present, a lot of oxidizing fluid is dispensed.
When there is little or no carbon buildup, little or no oxidizing fluid is dispensed. Thus, oxidizing fluid does not have to be dispensed continuously, but can be dispensed intermittently.
If the graphite or carbon electrodes show severe erosion, deposition of carbon on the electrodes may be desirable, and little or no oxidizing fluid is output also in this case. In addition, the first operating mode (A) is advantageous in this situation, because hydrocarbon fluid is passed through the intermediate space 31 between the inner tube 28 and the outer tube 30, i.e., close to the inner electrode 18.
If a severe reduction in mass flow is detected at one of the outlets 25 or 26 of the feed lance 22, oxidizing fluid may be dispensed specifically through the affected outlet 25 or 26.

Additionally, variable mixing of hydrocarbon fluid, CO2 and/or H2O may be based on measured wear of at least one of the tubular electrodes or based on measured amount of deposition of solids (i.e. solid carbon deposits) on one of the tubular electrodes. For example, the wear or amount of a deposit of solids can be measured optically, e.g., via laser, camera, or other known optical methods.

In all embodiments of the method described above, plasma gas may be emitted through the annular gap 23 between the inner tubular electrode 18 and the feed lance 22 to blow C particles away from the inner electrode 18.

In all of the embodiments of the method described above, a cooling gas having a lower temperature than the inner electrode 18 may be fed through the feed lance 22 when no hydrocarbon fluid is dispensed. Further, in all embodiments of the method described above, the feed lance may be axially displaced relative to the inner tubular electrode. In either case, the feed lance 22 may be protected from heat damage when the cooling effect of the hydrocarbon fluid is eliminated. The introduction of cooling gas may be beneficial during start and stop of operation.

In addition, the flow characteristics and turbulence of the fluids dispensed through the feed lance 22 can be affected by means of a combined adjustment of (i) the axial position of the feed lance 22, (ii) the amount or pressure of the dispensed fluids, and (iii) the amount or pressure of a plasma gas dispensed through the annular gap 23.

In all embodiments, any suitable gas or gas mixture can be selected as plasma gas, which is supplied from the outside to the plasma reactor or is generated in the plasma reactor 1. As an example, inert gases are suited as plasma gas, e.g. argon or nitrogen. On the other hand, H₂, CO or synthesis gas are suitable gases, since these gases are produced anyway when the hydrocarbons are decomposed.

In all embodiments, the plasma reactor 1 may have further inlets for CO₂ or H₂O (not shown in Figs.) which are arranged in the direction of the center axis 4 between the plasma torch 7 and the outlet 15, i.e. in the flow direction of the H₂/C aerosol. These further inlets for CO₂ or H₂O are positioned so far away in the direction of the center axis 4 from the plasma torch 7 that a temperature of more than 1200° C. prevails and preferably so far that more than 90% of a supplied hydrocarbon fluid is decomposed to H₂/C aerosol. In this case, the amount of CO₂ or H₂O supplied into the reactor chamber 2 through the further inlets for CO₂ or H₂O is preferably greater than the amount of oxidizing fluid supplied through the feed lance 22. However, for a simple embodiment, it is also possible to supply the entire amount of oxidizing fluid (CO₂ and/or H₂O), that is required for the process in the plasma reactor 1, through the feed lance 22.

Furthermore, in all embodiments of the method described above, a pressure within the reactor chamber can be adjusted to a range of 10 to 30 bar. Likewise, in all of the above-described embodiments of the method, a temperature at the inlet of the heat exchanger can be adjusted to 1100-1300° C., preferably 1200° C.

The concepts described here have been described in connection with a plasma reactor for decomposing a hydrocarbon fluid, but can also be applied to other plasma reactors and plasma torches whose operation is affected by deposits on the electrodes or outlets.

The invention has been described with reference to preferred embodiments, wherein the individual features of the described embodiments may be freely combined and/or interchanged, provided that they are compatible. Likewise, individual features of the described embodiments can be omitted, provided they are not absolutely necessary. For the person skilled in the art, numerous variations and embodiments are possible and obvious within the wording of the claims.

1. A plasma reactor (1) for decomposing a hydrocarbon fluid, comprising:
a reactor chamber (2) and a plasma torch (7) attached to a wall of the reactor chamber (2), projecting into the reactor chamber (2) and having a free end (12),
the plasma torch (7) comprising an inner tubular electrode (18) and an outer tubular electrode (20) which at least partially surrounds the inner tubular electrode (18),
a feed lance (22) for dispensing hydrocarbon fluid, which is arranged inside the inner tubular electrode (18) and is displaceable relative to the tubular electrodes (18, 20) by means of a sliding mechanism;
a plasma gas outlet for dispensing plasma gas between the inner tubular electrode (18) and the outer tubular electrode (20);
an oxidizing fluid outlet for dispensing oxidizing fluid,
wherein the oxidizing fluid comprises CO₂ or H₂O,
wherein the oxidizing fluid outlet is disposed within the inner tubular electrode (18).

2. The plasma reactor (1) of claim 1, wherein the oxidation fluid outlet is a part of the feed lance (22), or formed by a gap (23) between the inner tubular electrode (18) and the feed lance (22).

3. The plasma reactor (1) according to claim 2, wherein a structure shaped to create a turbulence of the dispensed hydrocarbon fluid, CO₂ and/or H₂O is provided in the feed lance (22) or in the oxidation fluid outlet.

4. The plasma reactor (1) according to claim 1, wherein the feed lance comprises an inner tube and an outer tube, which at least partially surrounds the inner tube, and wherein the oxidation fluid outlet is formed either by the inner tube or by a space between the inner tube and the outer tube of the feed lance.

5. The plasma reactor (1) according to claim 1, wherein the feed lance is connected to the inner electrode by at least one electrically conductive element;
or wherein an insulation layer is provided on the inner electrode or on the feed lance, the insulation layer being both electrically insulating and insulating against heat.

6. The plasma reactor (1) according to claim 1, comprising an annular magnet (14) arranged externally on the reactor wall (3, 3a, 3b) at the level of the free end (12) of the electrodes (18, 20); wherein a part of the reactor wall near the magnet is made of an austenitic metal including austenitic steel, stainless steel or metal mixtures with an austenitic portion.

7. The plasma reactor (1) according to claim 1, wherein the reactor chamber (2) comprises an outlet (15) opposite to the plasma torch (7), and wherein a heat exchanger (17) is arranged directly at the outlet (15) of the reactor chamber (2).

8. The plasma reactor (1) of claim 7, configured to generate a stream of synthesis gas comprising CO and H₂, and wherein the heat exchanger (17) is adapted to effect cooling of the stream of synthesis gas by 800 to 1000° C.; and
wherein the heat exchanger (17) is configured to effect cooling of the stream of synthesis gas within 1-3 seconds,

9. A method of operating a plasma reactor (1) according to claim 1, the method comprising the steps of:
measuring a mass flow of the oxidizing fluid or of the hydrocarbon fluid prior to dispense within the inner tubular electrode (18);
controlling the dispense of oxidizing fluid from the oxidizing fluid outlet based on at least one of a change in a mass flow of the oxidizing fluid or
a change in the a pressure of the oxidizing fluid.

10. The method of claim 9, which comprises the step of:
variable mixing of hydrocarbon fluid, CO₂ and/or H₂O,
wherein said variable mixing of hydrocarbon fluid, CO₂ and/or H₂O is based on at least one of a wear of at least one of said tubular electrodes (18, 20) or
an amount of deposition of solids on at least one of said tubular electrodes (18, 20).

11. The method of claim 9, wherein the feed lance (22) is axially displaced relative to the inner tubular electrode based on a change in a mass flow or a pressure.

12. The method of claim 9, wherein dispensing the oxidizing fluid is carried out via an outlet that is part of the feed lance, and the feed lance comprises an inner tube and an outer tube that at least partially surrounds the inner tube.

13. The method of claim 9, wherein dispensing the oxidizing fluid is performed through an outlet in the feed lance which comprises a first outlet for oxidizing fluid and a second outlet for hydrocarbon fluid,
through an annular space between the inner tubular electrode and the feed lance.

14. The method of claim 13 wherein oxidizing fluid is passed between the inner surface of the inner electrode and an outer periphery of the feed lance, or the hydrocarbon fluid and the oxidizing fluid are dispensed through a single or common tube of the feed lance, (a) alternating in time through the same tube, or (b) mixed together.

15. The method of claim 12 wherein the method provides the step of passing the oxidizing fluid through the inner tube and passing the hydrocarbon fluid through a space between the inner tube and the outer tube, or passing the oxidizing fluid through a space between the inner tube and the outer tube of the feed lance.
